(19) United States
(12) Patent Application Publication
(10) Pub. No.: US 2012/0242719 A1
(43) Pub. Date: Sep. 27, 2012

(54) MULTI-PRIMARY DISPLAY

(75) Inventors: Michel Adriaanszoon Klompenhouwer, Eindhoven (NL); Erno Hermanus Antonius Langendijk, Eindhoven (NL); Aleksandar Sevo, Eindhoven (NL)

(73) Assignee: KONINKLIJKE PHILIPS ELECTRONICS N.V., EINDHOVEN (NL)

(21) Appl. No.: 13/512,914

(22) PCT Filed: Nov. 25, 2010
(86) PCT No.: PCT/IB10/55407

§ 371 Date: May 31, 2012

(30) Foreign Application Priority Data
Dec. 1, 2009 (EP) 09177608.8

(51) Int. Cl. G09G 5/10

(52) U.S. Cl. 345/690

(57) ABSTRACT

A multi-primary display with more than three additive primaries comprises a spatial repetition of a pixel repetition block. The block comprises a first pixel row (1201) of pixels of primaries. Each pixel is divided into a plurality of sub-pixels including at least a higher luminance sub-pixel adjacent to a lower luminance sub-pixel. The first pixel row (1201) forms a first sub-pixel row (1203) and a complementary sub-pixel row (1205) adjacent to each other and comprising complementary sub-pixels. The sub-pixels are arranged such that a difference between a first combined maximum luminance for higher luminance sub-pixels of the first sub-pixel row (1203) and a second combined maximum luminance for higher luminance sub-pixels of the complementary sub-pixel row (1205) is no more than 30% of a sum of the first combined maximum luminance and the second combined luminance. The invention may provide an improved display with e.g. reduced pixel structure visibility.

### FIELD OF THE INVENTION

The invention relates to a multi-primary display employing more than three primary colors, and in particular, but not exclusively to pixel and sub-pixel arrangements for a six primary colour display.

### BACKGROUND OF THE INVENTION

Traditional displays, such as conventional Liquid Crystal Display (LCD) displays, typically use three primary colors (Red, Green and Blue: RGB) to reproduce a full gamut of colors. These primaries are made by a mosaic of color filters on the screen, where each image colour point of RGB consists of three primary colour pixels with respectively an R, G and B color filter. Three primaries are sufficient to reproduce most of the visible colors but cannot cover the entire gamut. Recently displays using a number of additional primaries have been proposed. Such displays with more than three primaries promise a number of advantages and are known as ‘multi-primary displays’. Multi primary displays may e.g. use four primaries (adding Yellow: RGBY, or White: RGBW), five primaries (additionally including Cyan: RGBYC), or six primaries (additionally including Magenta: RGBYCM).

Thus, in the last decade there has been a growing interest in construction of multi-primary displays. Indeed, although displays have advanced significant they are still not able to render real scenes perfectly and there is a continuing drive towards further improvement. E.g., the geometry of most scenes (size, 3D appearance, etc) cannot be perfectly rendered on current displays, but rather an approximate appearance is provided which the human perception is capable of understanding and accepting as a representation of the scene. Also, the color reproduction of a scene is limited and cannot represent the actual scene perfectly (e.g. the grey value dynamic range may be too low, dark regions may not be rendered accurately etc).

A particular problem is the accurate rendering of a large variety of colors. Indeed, a three primary additive color display is only capable of rendering colors within the triangular gamut defined by the three primaries. This may reduce the accuracy of the colour reproduction as the real world colors may be partially subtractive or may be outside this triangular gamut. In order to address such issues, multi-primary displays with more than three primaries may be used. Such additional primaries may e.g. introduce an additional yellow, magenta, cyan, purplish blue, or orange.

One advantage of the additional primaries (Y,C, etc) is that these usually have a higher transmission resulting in such displays typically being brighter and/or more efficient. Also, the primaries can be made more saturated without loss of efficiency, and the gamut area can be designed with more freedom than with RGB, thereby enabling a wider gamut. Another advantage is that white can be made with different combinations of primaries, and this can be used to increase the resolution of the display (at least for white or not too saturated colors). For example, in an RGBY display, white can be made using R+G+B and B+Y. It is commonly expressed that an RGBY display, which has ‘unit pixels’ of RGBY instead of RGB, can make “two effective pixels per unit pixel”. For an RGBYC display it is possible to generate three effective pixels per unit pixel: R+G+B, Y+B, and C+R. For an RGBYCM display it is possible to generate six effective pixels; R+G+B, Y+C+M, R+C, G+M, and B+Y.

An important design consideration when designing displays is how to distribute pixels across the display. Typically, pixels are organized within a pixel repetition block which is then repeated across the display. However, the resulting pattern of pixels across the display may result in the pixel structure being more or less visible. However, whereas the structure of a three primary display is relatively straightforward, the addition of more primaries provides a large number of possible variations and complicates the trade-offs, interactions ad characteristics substantially. Accordingly, various pixel arrangements and patterns have been suggested for multi-primary displays. However, although these tend to provide suitable performance in many scenarios, they are not ideal and may in particular in some cases result in the pixel structure being relatively noticeable.

Furthermore, recently displays have been proposed wherein the individual primary pixels are divided into at least two sub-pixel elements that are driven differently to provide different luminances. These displays use a non-uniform distribution of luminance within each pixel and in particular each primary colour pixel may be divided into two areas (a and b), which are driven with (typically) different luminances and such that their average luminance is the desired luminance of the whole pixel (i.e. it follows the desired gamma curve). In particular the a and b sub-pixels are respectively driven to be as bright or dark as possible (thereby avoiding mid-grey in the a/b sub-pixel domains). Since the mid-grey driving results in the largest color shift with off-axis viewing, the multi-domain driving increases viewing angle. Effectively, the driving results in all dark sub-pixel domains for dark image parts, in all bright sub-pixel domains for bright image parts, and in one bright and one dark sub-pixel for mid-grey image parts.

An example of a three primary display wherein each pixel of an RGB display is divided into two areas with different luminances (a bright area and a dark area b) is illustrated in FIG. 1. FIG. 2 illustrates the corresponding gamma curves for the bright area a, the dark area b and the pixel as a whole.

However, a problem associated with the multi-domain driving of pixels is that it may significantly affect the characteristics resulting from the specific pixel structure. In particular, it may make the pixel or sub-pixel structure more visible or may reduce the effective resolution. Thus, the arrangement of not only the pixels but also the sub-pixels is critical for the perceived image quality.

Hence, an improved multi-primary display would be advantageous and in particular a display allowing facilitated implementation and/or operation, reduced pixel and/or sub-pixel structure visibility, increased effective resolution, improved image quality and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a multi-primary display having more than three additive primaries, the multi-primary display comprising a spatial repetition of a pixel repetition block, the pixel repetition block comprising a first pixel row of pixels of primaries, each primary having an associated maximum luminance and each pixel being divided into a plurality of sub-pixels including at least a higher luminance sub-pixel adjacent to a lower luminance sub-pixel, the first pixel row having a plurality of sub-pixels forming at least a first sub-pixel row of the pixel repetition block and a complementary sub-pixel row of the pixel repetition block, the complementary sub-pixel row being adjacent to the first sub-pixel row and comprising a complementary sub-pixel for each sub-pixel of the first sub-pixel row, wherein the sub-pixels are arranged such that a difference between a first combined maximum luminance for higher luminance sub-pixels of the first sub-pixel row and a second combined maximum luminance for higher luminance sub-pixels of the complementary sub-pixel row is no more than 30% of a sum of the first combined maximum luminance and the second combined luminance.

The invention may provide an improved multi-primary display in many embodiments. In particular, the approach may reduce visibility of the pixel and/or sub-pixel structure. The approach may further provide an advantageous effective resolution of the display. Also, the advantages may be provided while using primary pixels that are divided into a brighter and darker sub-pixel thereby allowing for a design with improved off axis viewing. The approach may in particular reduce visibility of the individual subpixel rows.

In some embodiments, the combined maximum luminance for higher luminance sub-pixels of the complementary sub-pixel row is no more than 20%, 10% or even 5% of the sum of the first combined maximum luminance and the second combined luminance. This may provide even more advantageous performance.

The maximum luminance for a pixel and/or sub-pixel corresponds to the highest output luminances that can be generated by that pixel/sub-pixel. Thus, it corresponds to the luminance provided for the highest (brightest) drive value for the pixel/sub-pixel. The maximum luminance for a pixel and/or sub-pixel may specifically correspond to the brightest possible light radiation from the pixel/sub-pixel.

The higher luminance sub-pixel has a higher luminance relative to the lower luminance sub-pixel for at least some luminance values of the corresponding pixel (e.g. the higher luminance sub-pixel may have a higher luminance relative to the lower luminance sub-pixel for at least some average luminance values of the higher luminance sub-pixel and the lower luminance subpixel). The higher luminance sub-pixel does not have a lower luminance than the lower luminance sub-pixel for any luminance value of the corresponding pixel. The higher luminance sub-pixel is brighter than the lower luminance sub-pixel for at least some luminance values of the corresponding pixel. The higher luminance sub-pixel has a luminance not lower than the luminance of the lower luminance sub-pixel. The pixel may thus be considered to be divided into (at least) a bright(er) sub-pixel and a dark(er) sub-pixel.

The complementary sub-pixel for a given sub-pixel is the sub-pixel for the same pixel having the complementary luminance. Specifically, the complementary sub-pixel for a higher luminance sub-pixel is a lower luminance sub-pixel, and the complementary sub-pixel for a lower luminance sub-pixel is a higher luminance sub-pixel.

The combined maximum luminance for higher luminance sub-pixels may be generated as a function combining the maximum luminances of only the higher luminance sub-pixels. Thus, the luminance of the lower luminance sub-pixels in the sub-pixel row may be discarded when calculating the combined maximum luminance. The combined maximum luminance may in some embodiments be determined as a summation of the maximum luminance of the higher luminance sub-pixels in the sub-pixel row (possible with each maximum luminance being weighted in the summation).

The rows may be in any suitable direction within the pixel repetition block. For example, the rows may be horizontal or vertical. The terms horizontal and vertical may be considered to relate to the display such that the horizontal and vertical directions may be parallel to the sides of a rectangular display.

The term arranged does not imply an action to be performed but refers to the structure of the pixel repetition block.

The first pixel row may specifically comprise one pixel for each primary. Similarly, each sub-pixel row may comprise one sub-pixel from each pixel in the pixel row and thus may each comprise one sub-pixel for each primary. The multi-primary display may e.g. have four, five or six primaries.

In accordance with an optional feature of the invention, the sub-pixels are arranged such that the difference between the first combined maximum luminance and the second combined maximum luminance is minimized.

This may provide particularly advantageous performance and may in particular reduce sub-pixel structure visibility in many embodiments.

In accordance with an optional feature of the invention, the pixel repetition block further comprises at least two pixels for each primary, the pixel repetition block comprising a second pixel row of pixels of primaries, the second pixel row having a plurality of sub-pixels forming at least a second sub-pixel row and a second complementary sub-pixel row, the second complementary sub-pixel row being adjacent to the second sub-pixel row and comprising a complementary sub-pixel for each sub-pixel of the second sub-pixel row, and wherein an order of primaries in the first pixel row is different than an order of primaries in the second pixel row.

This may provide particularly advantageous performance and may in particular reduce sub-pixel structure visibility in many embodiments. The approach may for example allow increased flexibility and chrominance/luminance variation while maintaining a manageable pixel repetition block size.

In accordance with an optional feature of the invention, the first sub-pixel row and the second complementary sub-pixel row comprise identical sub-pixels.

This may provide particularly advantageous performance in many embodiments. Similarly, the second sub-pixel row and the first complementary sub-pixel row may also comprise identical sub-pixels.

In accordance with an optional feature of the invention, the first pixel row and the second pixel row are divided into a first part of consecutive pixels and a second part of consecutive pixels and an order of the first part and the second part is reversed for the second pixel row relative to the first pixel row.

This may provide particularly advantageous performance in many embodiments. In particular, it may provide a particularly advantageous combination of chrominance and luminance variations that can reduce sub-pixel structure visibility while at the same time providing a structure suitable for a high image resolution. Specifically, an increased effective image pixel resolution can be achieved.

The first part and the second part may specifically have an equal number of pixels. The first and second part may together include all pixels.

In accordance with an optional feature of the invention, the first pixel row is divided into a first part of consecutive pixels and a second part of consecutive pixels and pixels are arranged such that a difference between a first combined maximum pixel luminance for the first part and a second combined maximum pixel luminance for the second part is no more than 30% of a sum of the first combined maximum pixel luminance and the second combined maximum pixel luminance.

This may provide particularly advantageous performance in many embodiments. In particular, it may provide a particularly advantageous combination of chrominance and luminance variations that can reduce sub-pixel structure visibility while at the same time providing a structure suitable for a high image resolution. Specifically, an increased effective image pixel resolution can be achieved.

The first part and the second part may specifically have an equal number of pixels. The first and second part may together include all pixels.

In some embodiments, the difference may advantageously be no more than 20%, 10% or even 5%.

The second pixel row may equally be divided into a first part of consecutive pixels and a second part of consecutive pixels and pixels are arranged such that the difference between the combined maximum pixel luminance for the first part and second parts is no more than 30% (20%/10%/5%) of the sum of the combined maximum pixel luminances.

The feature may e.g. be combined with the feature of the order of the first part and second part being reversed for the second pixel row relative to the first pixel row.

In accordance with an optional feature of the invention, wherein an order of pixels in the first part is such that a sum of luminance variations between neighboring pixels of the first part is maximized.

This may in combination with the low luminance variation between the parts provide a highly advantageous display where in particular the visibility of the sub-pixel structure is substantially minimized. In particular, the variation may provide a pixel to pixel high frequency luminance variation that may result in reduced visibility of the sub-pixel structure while providing suitable areas of the pixel repetition block for individual representation of image data thereby increasing the effective resolution of the display.

In accordance with an optional feature of the invention, the first pixel row is divided into a first part of consecutive pixels and a second part of consecutive pixels and pixels are arranged such that a chromatic difference between pixels of the first part and pixels for the second part is minimized.

This may provide particularly advantageous performance in many embodiments. In particular, it may provide a particularly advantageous combination of chrominance and luminance variations that can reduce sub-pixel structure visibility while at the same time providing a structure suitable for a high image resolution. Specifically, an increased effective image pixel resolution can be achieved. In particular, suitable chrominance variation may be achieved within each of the two parts thereby allowing for these to individually cover relatively large colour gamuts.

The first part and the second part may specifically have an equal number of pixels. The first and second part may together include all pixels.

The feature may e.g. be combined with the feature of the order of the first part and second part being reversed for the second pixel row relative to the first pixel row.

In accordance with an optional feature of the invention, the first pixel row is divided into a first part of consecutive pixels comprising magenta, green and blue pixels and a second part of consecutive pixels comprising red, yellow and cyan pixels.

This may provide particularly advantageous performance in many embodiments. In particular, it may provide a particularly advantageous combination of chrominance and luminance variations that can reduce sub-pixel structure visibility while at the same time providing a structure suitable for a high image resolution. Specifically, an increased effective image pixel resolution can be achieved.

In accordance with an optional feature of the invention, the first sub-pixel row comprises a higher luminance magenta sub-pixel, a lower luminance green sub-pixel, a higher luminance blue sub-pixel, a lower luminance red sub-pixel, a higher luminance yellow sub-pixel, and a lower luminance cyan sub-pixel.

This may provide particularly advantageous performance in many embodiments. In particular, it may provide a particularly advantageous combination of chrominance and luminance variations that can reduce sub-pixel structure visibility while at the same time providing a structure suitable for a high image resolution. Specifically, an increased effective image pixel resolution can be achieved.

The pixels may specifically be arranged in the described order.

In accordance with an optional feature of the invention, the pixel repetition block further comprises at least two pixels for each primary, the pixel repetition block comprising a second pixel row of pixels of primaries, the second pixel row having a plurality of sub-pixels forming at least a second sub-pixel row and a second complementary sub-pixel row, the second complementary sub-pixel row being adjacent to the second sub-pixel row and comprising a complementary sub-pixel for each sub-pixel of the second sub-pixel row, and wherein the second sub-pixel row comprises a lower luminance magenta sub-pixel, a higher luminance green sub-pixel, a lower luminance blue sub-pixel, a higher luminance red sub-pixel, a lower luminance yellow sub-pixel, and a higher luminance cyan sub-pixel.

This may provide particularly advantageous performance in many embodiments. In particular, it may provide a particularly advantageous combination of chrominance and luminance variations that can reduce sub-pixel structure visibility while at the same time providing a structure suitable for a high image resolution. Specifically, an increased effective image pixel resolution can be achieved.

The pixels may specifically be arranged in the described order.

In accordance with an optional feature of the invention, the first pixel row comprises a plurality of pixels for at least a first primary.

This may provide improved performance in some embodiments. In particular, it may allow lower luminance primary pixels to be represented by more than one pixel thereby allowing a brighter representation of corresponding pixels.

In accordance with an optional feature of the invention, the first sub-pixel row comprises a higher luminance red sub-pixel, a lower luminance green sub-pixel, a higher luminance blue sub-pixel, a lower luminance red sub-pixel, a higher luminance yellow sub-pixel, and a lower luminance cyan sub-pixel.

This may provide particularly advantageous performance in many embodiments. In particular, it may provide a particularly advantageous combination of chrominance and luminance variations that can reduce sub-pixel structure visibility while at the same time providing a structure suitable for a high image resolution. Specifically, an increased effective image pixel resolution can be achieved.

The pixels may specifically be arranged in the described order.

In accordance with an optional feature of the invention, the first sub-pixel row comprises alternating higher luminance sub-pixels and lower luminance sub-pixels.

This may provide particularly advantageous performance in many embodiments.

According to an aspect of the invention there is provided a method of providing a multi-primary display having more than three additive primaries, the multi-primary display comprising a spatial repetition of a pixel repetition block, the pixel repetition block comprising a first pixel row of pixels of primaries, each primary having an associated maximum luminance and each pixel being divided into a plurality of sub-pixels including at least a higher luminance sub-pixel adjacent to a lower luminance sub-pixel, the first pixel row having a plurality of sub-pixels forming at least a first sub-pixel row of the pixel repetition block and a complementary sub-pixel row of the pixel repetition block, the complementary sub-pixel row being adjacent to the first sub-pixel row and comprising a complementary sub-pixel for each sub-pixel of the first sub-pixel row, the method comprising: arranging the sub-pixels such that a difference between a first combined maximum luminance for higher luminance sub-pixels of the first sub-pixel row and a second combined maximum luminance for higher luminance sub-pixels of the complementary sub-pixel row is no more than 30% of a sum of the first combined maximum luminance and the second combined luminance.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of an example of pixel repetition blocks for an RGB display;

FIG. 2 is an illustration of exemplary gamma driving curves for a multi-domain display;

FIGS. 3 and 4 illustrates examples of pixel structures for a six primary display;

FIGS. 5 and 6 illustrate examples of pixel repetition blocks for a six primary display;

FIGS. 7 and 8 illustrate examples of pixel repetition blocks for a six primary multi-domain display;

FIG. 9 illustrates a sub-pixel structure for a six primary multi-domain display;

FIGS. 10 and 11 illustrate examples of pixel repetition blocks for a six primary multi-domain display; and

FIGS. 12 to 19 illustrate examples of pixel repetition blocks for a multi-primary display in accordance with some embodiments of the invention.

### DETAILED DESCRIPTION OF SOME EMBODIMENTS OF THE INVENTION

The following description focuses on embodiments of the invention applicable to a multi-primary display using six different primaries. However, it will be appreciated that the invention is not limited to this application but may be applied to many other display including for example displays using 4, 5 or 8 primaries.

In the following description different terms will be used. Specifically, the term unit pixel will be used to be equivalent to a pixel repetition block and will be refer to a pattern of primary pixels which is repeated across the display to generate the pattern for the whole display.

The term primary colour or primary pixel will be used to refer to a single color pixel, such as e.g. an R pixel, a G pixel or a B pixel. Thus, in the example, the individual color points of the image are represented by the combined light of a plurality of primary colour pixels. The primary colour pixels/primary pixels are often simply referred to as pixels for brevity and convenience. The term primary color or primary pixel will thus refer to what is sometimes in the art referred to as a primary color sub-pixel in cases where the combined total colour point (i.e. including the contribution from all primary colors) is referred to as a pixel.

The term sub-pixel is used for individual divisions of a primary color pixel. Specifically, a primary colour pixel (or just pixel) may be divided into a plurality of subpixels.

The term effective pixel or image pixel is used to determine the degree of freedom in separately setting luminance values for a given gamut or white. Thus, an effective pixel or image pixel is used to refer to the finest resolution that can be separately defined by the panel. For example, the unit pixel typically allows the representation of more than one colour point by suitable driving the individual pixels and each of these colour points may be considered to correspond to an effective pixel. Thus, the effective pixels correspond to the image colour points that can be individually represented.

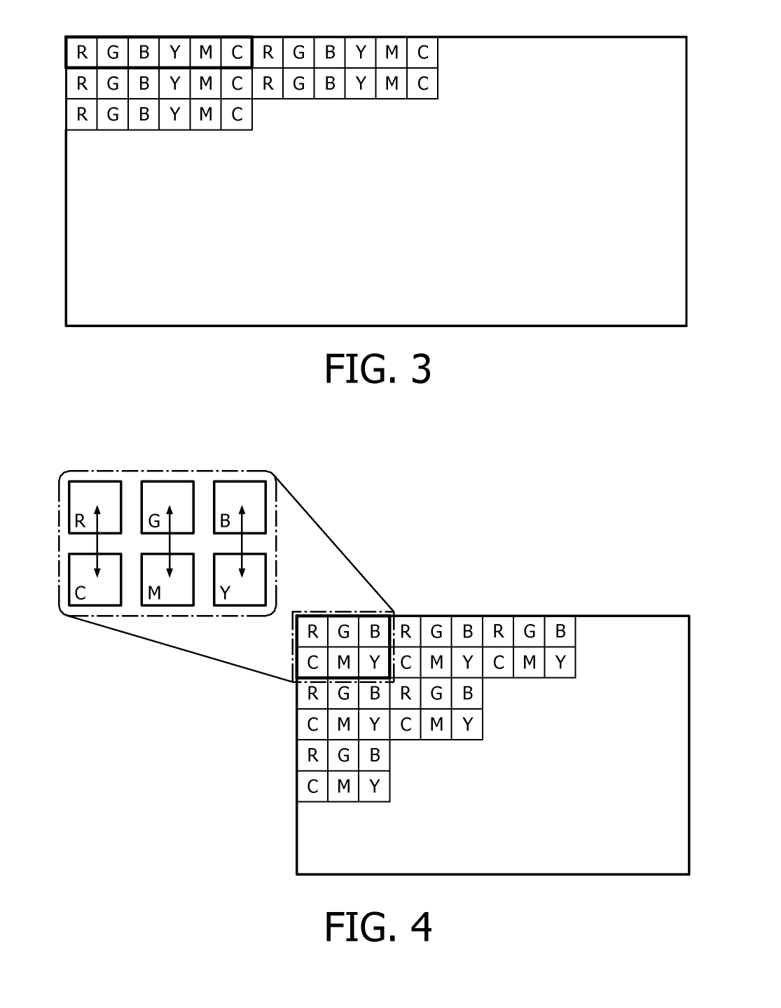

Displays such as LCD, OLED, etc are formed by a large number of pixels covering a typically rectangular display area. In order to facilitate the driving and manufacturing of such displays, the pixels are normally arranged by repeating a specific pixel block across the screen. Such a pixel repetition block is typically rectangular and is repeated in both the horizontal and vertical direction. An example is shown in FIG. 3 for a six primary (RGBYMC) display.

The distribution of pixels across the display is of critical importance for the achievable image quality. As the structure is determined by the pixel repetition block, the structure and specifically the ordering of pixels within this pixel repetition block is of critical importance.

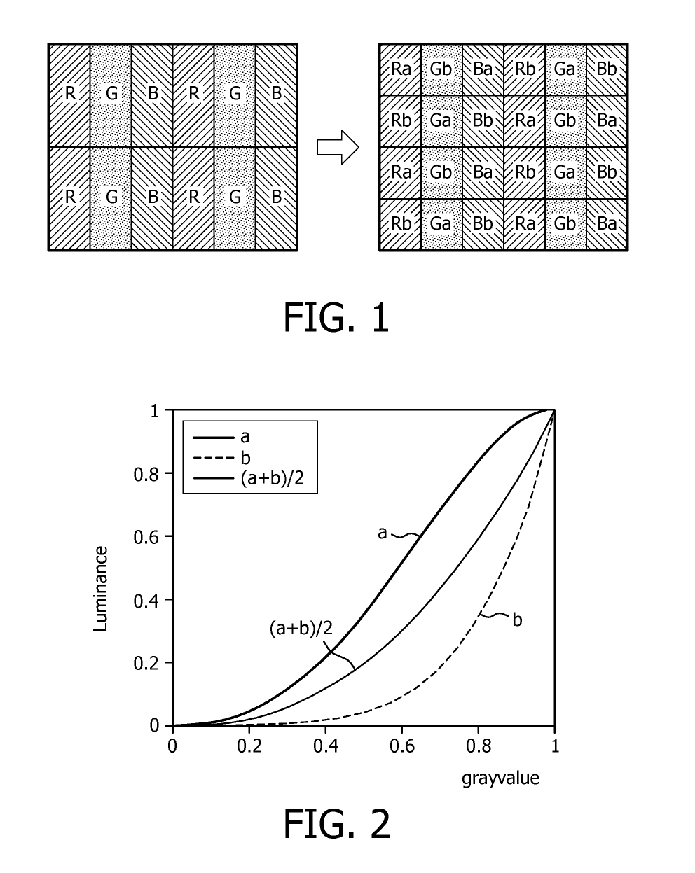

In many traditional colour displays, three primaries, RGB, are used together with a simple pixel repetition block comprising an R pixel, a G pixel and a B pixel (as e.g. illustrated in FIG. 1). In such an embodiment, each pixel repetition block (unit pixel) may correspond to an image pixel/effective pixel which can be set individually to represent one colour value of the presented image. Specifically, an input image may be received which is represented by a plurality of RGB values. Each of such image pixel values may be used directly to set the RGB luminances for one pixel repetition block. Thus, in such an example, each effective pixel may correspond to one pixel repetition block and thus one unit pixel. However, each pixel repetition block or unit pixel comprises three primary colour pixels.

In multi-primary displays, more than three primary colors are used and thus the pixel repetition block (or unit pixel) will comprise more than three primary colour pixels. An example of a conventional pixel repetition block for a traditional six primary display is shown in FIG. 3. In the example, a pixel repetition block comprises of a single row of six pixels (one for each primary). However, for six primary displays, different colors can be generated in more than one way and this is typically used to provide an image resolution which is higher than a single pixel repetition block. For example, a six primary display is typically used to provide two effective pixels for each pixel repetition block. However, the design of FIG. 3 is not ideally suited for generation of a finer resolution than the pixel repetition block because the pixels are not arranged to generate areas within the pixel repetition block that may be used for different image pixels.

In order to address this, the pixel structure of FIG. 4 has been proposed. The major advantage of these configurations is that the primary pixels are arranged such that chromatically complementary colour combinations are placed close together. For example, in the example of FIG. 4, white can be generated by e.g. RC, GM, and BY. This allows a better resolution within the pixel repetition block as e.g. a white luminance can be generated by each of the pixel combinations (and thus a different white luminance can be generated for the left, the middle and the right of the pixel repetition block).

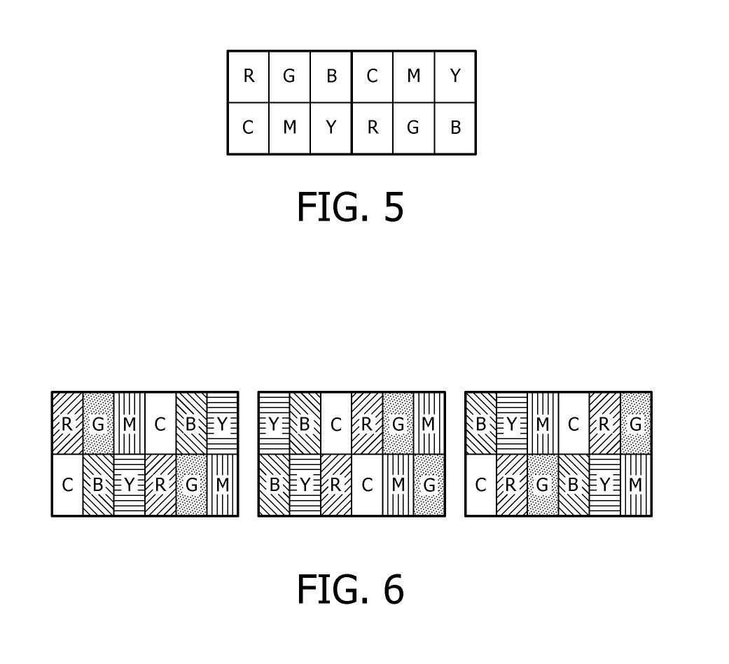

However, a problem associated with the arrangement of FIG. 4 is that it tends to generate a regular line pattern which may be visible in some scenarios. Thus, it may result in the pixel structure becoming visible to the viewer. In order to address this, an alternating approach may be used where adjacent pixel rows are not identical. An example of this is illustrated in FIG. 5. In this example, the order of the pixels is modified between different pixel rows such that the vertical colour lines are broken up. In particular, complementary colors may be placed vertically adjacent such that the combination ads up to white. This approach may be seen to correspond to a pixel repetition block having two rows and providing two image pixels for each pixel repetition block.

Such a pixel configuration is an improvement on the conventional striped configuration and provides a particularly advantageous effect for the perceived resolution of black & white images and images with de-saturated colors. However, the sub-pixel structure itself still tends to be visible and that partly degrades the perceived extra resolution, especially when the sub-pixels have a 1:3 aspect ratio (horizontal: vertical length of sub-pixel), as is typical for most displays.

It has been proposed that the substructure visibility is further reduced by minimizing the luminance and chrominance variations for visible modulation frequencies. This may be achieved by distributing bright and dark pixels as uniformly as possible over the screen together with an arrangement where complimentary colors as close to each other as possible.

FIG. 6 illustrates pixel repetition blocks that are designed in accordance with these underlying principles for an RGBCMY display, where the maximum luminance ratios are approximately R:G:B:C:M:Y=2:7:1:8:3:9 (C≈G+B, M≈R+B, Y≈R+G). In such a display, R, B and M are relatively dark whereas G, C and Y are relatively bright. In the examples, the RBM pixels are alternated with GCY pixels in order to generate a high frequency luminance variation. This results in a reduced visibility of the pixel structure.

The key attribute of these layouts is that the bright and dark pixels alternate (both in a sub-pixel row and by applying checkerboard layout), and that complementary color pixels are more or less adjacent (horizontally rather than vertically). In other words, the luminance and chrominance variation over the screen is made as high-frequent as possible. The illustrated variations are obtained by interchanging colors that are very similar (for example R and M or G and C). These pixel layouts are very effective in reducing visibility of the pixel structure and while optimizing resolution.

Recently, displays have been developed where the individual primary colour pixels are divided into two sub-pixels which are driven differently such that one sub-pixel is more luminant than the other sub-pixel for at least some luminance values. This sub-pixel is in the following referred to as the higher luminance pixel (and referenced to by the index a) and the other sub-pixel is in the following referred to as the lower luminance pixel (and referenced to by the index b). The two sub-pixels are thus characterized by a different relationship to the desired luminance value for the pixel and specifically the luminance for the two sub-pixels are described by two different gamma curves. Furthermore, the two sub-pixels are driven such that the combined luminances of the two sub-pixels add up to the desired luminance value for the whole pixel.

FIG. 1 illustrates the introduction of such a multi-domain driving of pixels made up by a higher and lower luminosity sub-pixel for an RGB display and FIG. 2 illustrates an example of the driving gamma curves. As illustrated in the example of FIG. 1, the pixel layouts are typically generated simply by introducing the sub-pixels to the existing pixel structure.

However, the inventors of the current invention have realized that the use of different luminosity sub-pixels for each primary colour pixel results in suboptimal pixel configurations using conventional approaches. In particular, they have realized that the existing pixel configurations exhibit disadvantages when used with multi-mode driving (different luminosity sub-pixels) and that substantially improved performance can be achieved by using principles that are based on the different luminosities of the sub-pixels. Thus, the inventors have realized that the use of different luminosity sub-pixels substantially and fundamentally alters the principles and considerations for generating a suitable pixel structure for a display.

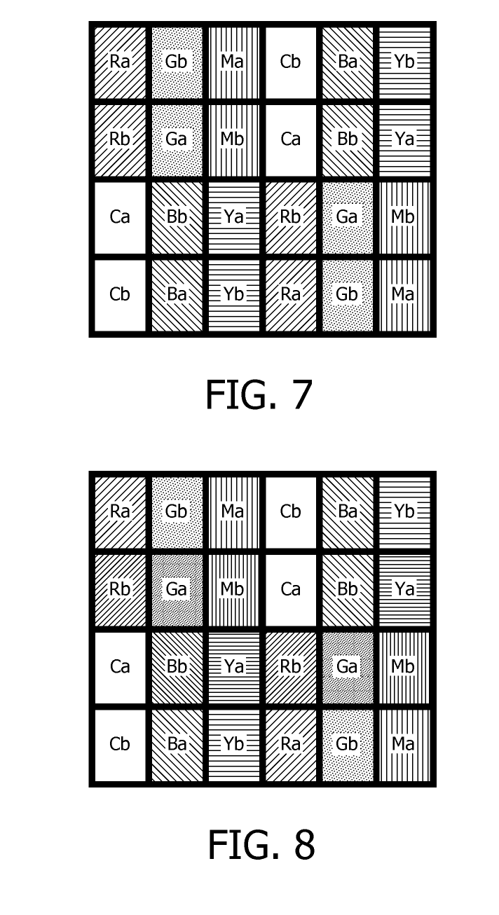

To illustrate how fundamentally the optimal configuration is modified by the introduction of different luminosity sub-pixels, FIG. 7 illustrates one of the pixel configurations of a pixel repetition block of FIG. 6. As can be seen, each of the pixels of the pixel repetition block of FIG. 7 is divided into two sub-pixels which are adjacent to each other (and which in the specific example together cover the entire pixel area).

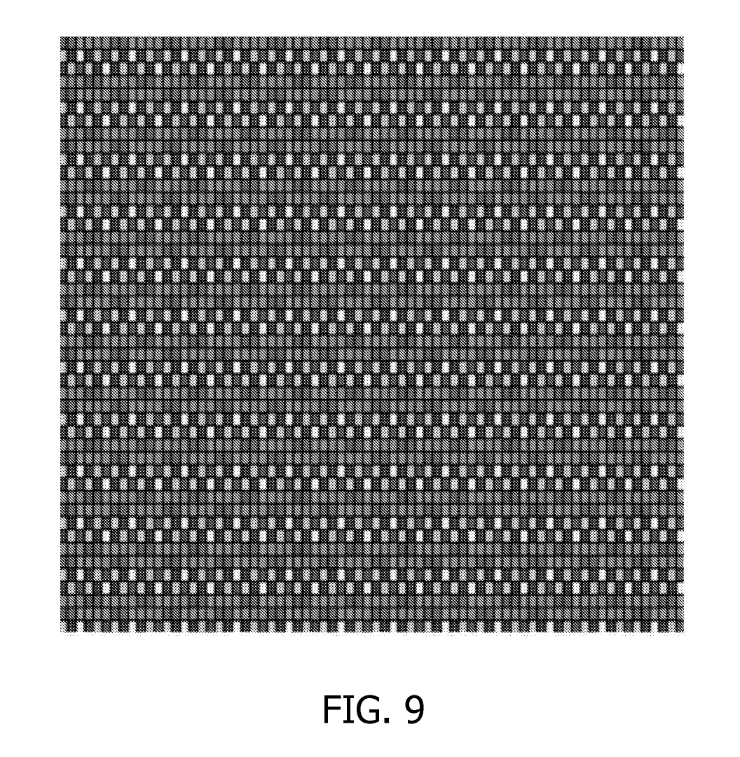

FIG. 7 illustrates how the pixel repetition block may look for a bright image. The result will correspond to that for the pixel repetition block of FIG. 6 and thus will result in the same reduced visibility of the substructure as for the pixel repetition block of FIG. 6. However, the inventors have realized that this is substantially different when a grey image is considered. An example of how the pixel repetition block may look for a grey area is illustrated in FIG. 8. As illustrated, the lower luminance sub-pixels are in this case relatively dark and the vast majority of the radiated light for each pixel is provided by the higher luminance sub-pixel. As a result, the first and third sub-pixel rows of FIG. 8 are predominantly characterized by the Ra, Ma and Ba sub-pixels whereas the second and third sub-pixel rows are dominated by Ga, Ca and Ya sub-pixels. However, this results in not only a substantial colour difference between every alternate pair of sub-pixel rows, but also in a significant luminance difference between the alternate pairs of sub-pixel rows since the GCY pixels are substantially lighter than the RMB pixels. As illustrated in FIG. 9, this may result in a line pattern which may make the sub-pixel structure visible.

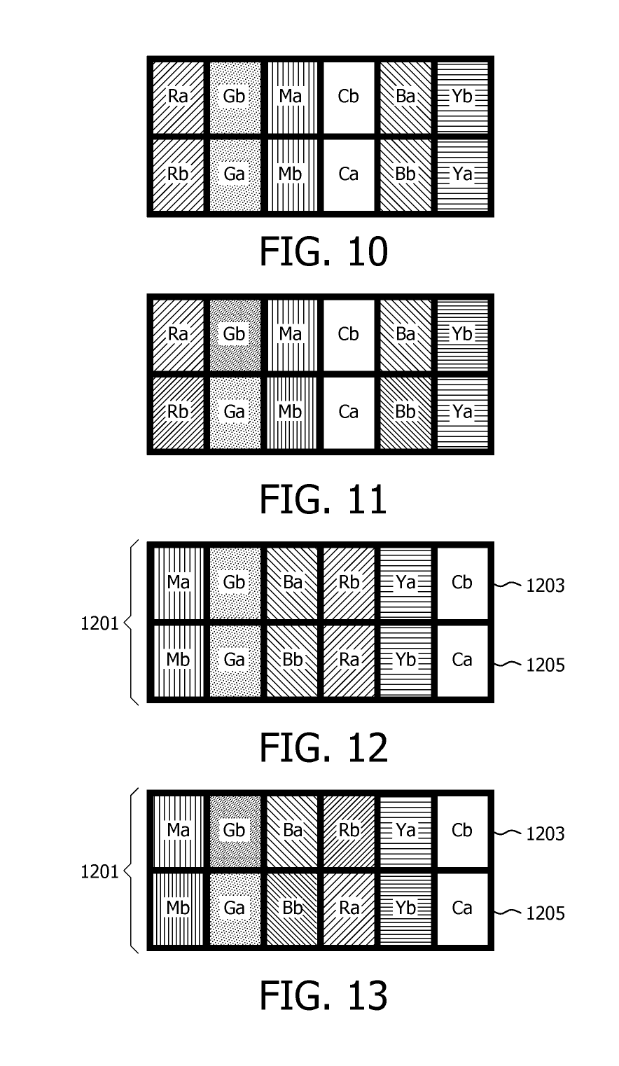

It will be appreciated that although this problem is particularly significant for the two-pixel row pixel repetition blocks of FIG. 6 due to the lower frequency of the line pattern, it is not limited to this example. For example, FIG. 10 illustrates an example of a single pixel row (two sub-pixel rows) pixel repetition block corresponding to a single pixel row of a pixel repetition block of FIG. 6. The pixel repetition block is illustrated in FIG. 11 for a mid-grey image. Again, it can be seen that every other line is dominated by either the RMB or the GCY pixel groups. Thus, the same line pattern is created albeit at double the spatial frequency.

Accordingly, it can be seen that the conventional approaches of pixel configuration are not suitable for the scenario where the primary colour pixels are divided into higher and lower luminance pixels.

In the following, a display is described which uses a pixel and sub-pixel configuration that seeks to provide an improved performance.

In the described approach, the pixel repetition block for the display comprises at least one pixel row comprising the primary pixels. Each of the primary colour pixels is divided into two sub-pixels with different luminances (although it will be appreciated that in some scenarios, each colour pixel may be divided into more than two different luminosity sub-pixels). The sub-pixels are driven such that one sub-pixel always has a luminance which is higher or the same as the luminance of the other sub-pixel.

Each pixel is characterized by a maximum luminance which is the highest luminance that can be generated by the pixel, i.e. it is the luminance that corresponds to the highest drive value. As will be well known to the skilled person, such a maximum luminance may vary substantially between different primaries due to e.g. the relative transparency of the colour filter, the relative sensitivity of the eye for that color, etc. Although, the maximum luminance is often attenuated for the specific images, it is particularly suitable for designing the pixel structure. This is due to the maximum luminance being a suitable measure for the actual relative luminances of the different pixels when the pixel structure is most visible and further because it is a suitable indicator of the ability of the effective pixels to provide the desired representation. For example, the colour gamut is defined by the maximum luminance values. Furthermore, it is particularly suitable for displays which use higher and lower luminance sub-pixels because the images are typically dominated by the higher luminance subpixel which is often driven close to the maximum value. Furthermore, because the maximum luminance varies so substantially between different primaries, it is often a limiting and thus characterizing factor for the performance of the display.

The division of the primary color pixels into the two different luminosity sub-pixels results in the formation of two sub-pixel rows. Each of the two sub-pixel rows may thus comprise one sub-pixel from each primary colour pixel. Furthermore, the two sub-pixel rows will comprise complementary sub-pixels such that if the first row comprises a higher luminance sub-pixel for a primary colour, then the other sub-pixel row will comprise the lower luminance sub-pixel (and vice versa). The rows will in the following be referred to as the first sub-pixel row and the complementary sub-pixel row.

In the described example, the arrangement of the pixels and sub-pixels is performed by also considering the luminance difference between the sub-pixels. In particular, the arrangement of the sub-pixel is made by particularly considering the higher luminance pixels such that the higher luminance pixels themselves have a reduced luminance variation between the two sub-pixels rows. In particular, the sub pixels are arranged such that the difference between the combined maximum luminances for the higher luminance sub-pixels of the two rows is no more than 30% of the sum of the two combined maximum luminances.

For example, the maximum luminance for all primary colour pixels that have a higher luminance sub-pixel in the first sub-pixel row may be added together to form a first combined value. The maximum luminance for all primary colour pixels that have a higher luminance sub-pixel in the complementary sub-pixel row may be added together to form a second combined value. The sub-pixels are arranged such that the difference between these two values is no more than 30% of the sum of the two values.

Accordingly, the design is not just based on a consideration of the maximum luminances of the pixels as such but particularly maintains a relatively low luminance variation between the rows when considering only the higher luminance sub-pixels. Thus, the pixel repetition block is generated to provide not only advantageous performance for bright images but may also provide improved performance at mid grey (mid luminance) levels and in particular such that the luminance line patterns for mid grey levels are kept relative weak.

In many embodiments, a particularly advantageous performance can be achieved by combining this approach with the use of a multi pixel row pixel repetition block. In particular, the pixel repetition block may comprise a second pixel row that also includes a set of primary pixels. In the same way as for the first pixel row, each of the primary colour pixels is divided into two sub-pixels with different luminances such that the first pixel row further define a second sub-pixel row and a second complementary sub-pixel row. In such an example, the sub-pixels of the second sub-pixel row and the second complementary sub-pixel row are also arranged such that the difference between a combined maximum luminance for the higher luminance sub-pixels of these two sub-pixel rows is no more than 30% of the sum of the two combined maximum luminances for the sub-pixel rows.

Furthermore, the first and second pixel rows may further be arranged such that they contain the same primaries (specifically all the primaries) but ordered in a different order. This may in particular be used to reduce the chance of a line pattern in a direction perpendicular to the direction of the two pixel rows. Indeed, the approach may seek to place complementary colour values close to each other. This may further improve the effective spatial image resolution within the pixel repetition block.

Thus, in the approach, the pixel and sub-pixel configuration is such that the (maximum) luminance between the higher luminance sub-pixels in one sub-pixel row is relatively close to the luminance of the higher luminance sub-pixels in the complementary sub-pixel row. In the example, this difference is kept to no more than 30% of the sum luminance of the sub-pixel rows. In many embodiments, it has been found particularly advantageous to keep the luminance difference to no more than 20%, 10% or even 5%. Indeed, in many embodiments, advantageous performance may be achieved by substantially minimizing the difference between the luminances of the higher luminance sub-pixels in the sub-pixel rows.

In many embodiments, the sub-pixels within each sub-pixel row alternate between being a higher luminance sub-pixel and being a lower luminance sub-pixel. Thus for two neighboring pixels in the pixel repetition block, one sub-pixel row will comprise the higher luminance sub-pixel of the first pixel and the lower luminance sub-pixel of the second pixel (and the other way round for the second sub-pixel row). This may provide improved image quality in many embodiments and may specifically provide a more homogeneous image.

Furthermore, a sub-pixel row for one pixel row may typically contain the same sub-pixels as the sub-pixel row of another pixel row. For example, the first sub-pixel row may comprise the same sub-pixels as the second complementary sub-pixel row (or the second sub-pixel row). At the same time, the first complementary sub-pixel row may comprise the same sub-pixels as the second sub-pixel row (or the second complementary sub-pixel row).

An example of a pixel repetition block that can be provided for an RGBCMY 6-primary display using a single pixel row pixel repetition block is illustrated in FIG. 12 for a bright image (approximately equal luminance of the higher luminance sub-pixels and the lower luminance sub-pixels) and in FIG. 13 for a mid grey image.

In the example, the pixel repetition block comprises single pixel row (1201) which is divided into a first sub-pixel row (1203) and a first complementary sub-pixel row (1205). As illustrated, the luminance variation between the first and second sub-pixel rows has been reduced substantially resulting in a substantially reduced visibility of the sub-pixel structure.

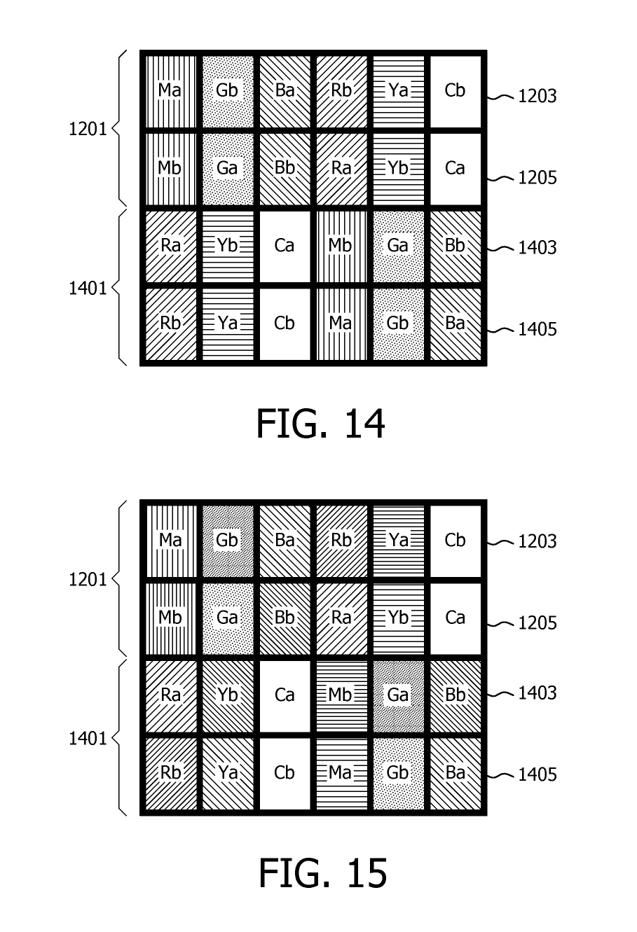

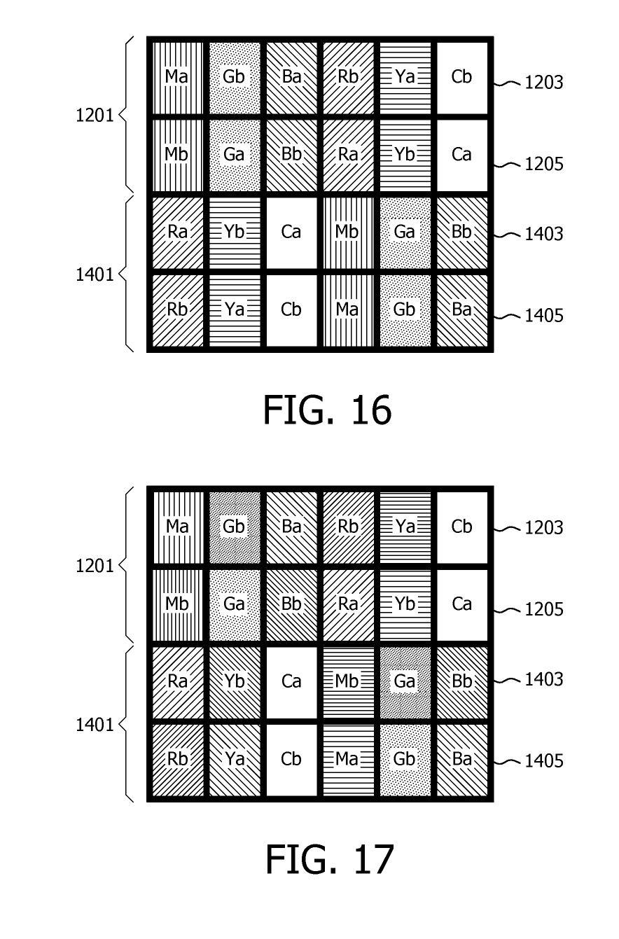

An example of a pixel repetition block that can be provided for an RGBCMY 6-primary display using a two pixel row pixel repetition block is illustrated in FIG. 14 for a bright image (approximately equal luminance of the higher luminance sub-pixels and the lower luminance sub-pixels) and in FIG. 15 for a mid grey image. Another example is provided in FIGS. 16 and 17.

In the example of FIGS. 14 and 15, the pixel repetition block of FIGS. 12 and 13 has been enhanced to further comprise a second pixel row (1401) which is divided into a second sub-pixel row (1403) and a second complementary sub-pixel row (1405). The same applies to the example of FIGS. 16 and 17.

As illustrated, a substantially reduced line pattern will result. Indeed for typical relative luminance values of R:G:B:C:M:Y=2:7:1:8:3:9, the example of FIGS. 14 and 15 will have a luminance variation for the first and second complementary sub-pixel rows 1203, 1405 of 13. The luminance variation for the second sub-pixel row 1403 and the first complementary sub-pixel row 1205 is 17. Thus, the luminance variation is 4/30=13.3%. The same is the case for the example of FIGS. 16 and 17 and indeed for the example of FIGS. 12 and 13 where the maximum luminances for the first sub-pixel row 1201 is 13 and for the second sub-pixel row 1205 is 17, i.e. the luminance variation is 4/30=13.3%. Thus, a much reduced visibility of any line structure is achieved while still managing to maintain a high effective resolution.

In the examples, the first sub-pixel row and the second complementary sub-pixel row comprises identical sub-pixels and similarly the second sub-pixel row and the first complementary sub-pixel row comprises identical sub-pixels. This may provide an advantageous image quality in many scenarios and in particularly may provide a more homogeneous appearance for the pixel repetition block.

It will be appreciated that in some embodiments the arrangement of pixels and sub-pixels may also seek to reduce a chrominance variation between sub-pixel rows. For example, the minimum chrominance difference that meets a required maximum luminance difference may be achieved by the ordering of the pixels and sub-pixels.

The arrangement of the pixels within the pixel repetition block and specifically within the pixel rows may further be performed such that improved image quality is obtained.

In particular, the pixels in the first pixel row may be divided into two parts of consecutive pixels where each part e.g. may effectively be used as an image pixel i.e. each of the two parts may be controlled to display different values in accordance with image data. Thus, each part may correspond to an effective pixel.

In some embodiments, the pixel row may thus be divided into a first and a second part. In order to provide a homogeneous performance, the arrangement may seek to provide for the two parts to be reasonably similar. Furthermore, in many embodiments, the two parts contain equal amounts of pixels and all pixels are allocated to either the first part or the second part.

For example, in the examples of FIG. 14-17, the first pixel row 1201 of the pixel repetition block is divided into a first part comprising the first three pixels and a second part comprising the last three pixels of the row 1201. The pixels are then allocated to either the first or second part dependent on the luminance. Indeed, in the specific examples, the pixels are divided such that MG and B pixels are grouped together and such that the R, Y and C pixels are grouped together. Thus, the three pixels MGB are grouped together to provide an effective image pixel which has a luminance of 11 and the three pixels RYC are grouped together to provide an effective luminance of 19. Thus, the pixels are allocated such that the luminance difference between two parts of the pixel row is maintained relatively low. In particular, advantageous performance can be achieved by keeping the luminance difference below 30% of the combined luminance. In the specific example, the luminance difference is 8/30−26.8%. Thus, the pixels are divided into two parts with each part corresponding to an image pixel value, i.e. it can be individually controlled to provide an image point which is different for the two parts. Thus, each part may specifically correspond to an effective image pixel. By keeping the luminance low, the two effective pixels are more homogeneous and in particular their dynamic brightness range may be maintained relatively similar thereby allowing for an improved image quality.

It will be appreciated that the same approach may be applied to the second pixel row for the example where the pixel repetition block comprises two pixel rows. Indeed, the two pixel rows may be divided into a first and second part of consecutive pixels. However, the order of the two parts may be interchanged between the two pixels lines. Thus, the order for the first pixel line may be the first part followed by the second part whereas the order for the second pixel line may be the second part followed by the first part.

Such an approach is for example used in the examples of FIG. 14-17 and may provide an improved image quality. In particular, a line effect in a direction perpendicular to the pixel rows may be reduced as the different characteristics for the two different effective pixels are alternated.

Similarly to the luminance considerations for the two parts, the pixel arrangement may alternatively or additionally take into consideration the chromatic characteristics of the pixels and the corresponding grouping. In particular, the pixels may be divided into the first and second part in such a way that the chromatic difference between the first and second part (i.e. the combined chromatic effect of the pixels in the first and second parts) is minimized. This minimization may be subject to one or more criteria. For example, the minimization may be performed with the constraint that the luminance difference between the two parts is below a given threshold.

The arrangement of the pixels within the first and second part, may specifically be done so that a luminance variation (and/or possibly a chrominance variation) between adjacent pixels within each part is maximized.

For example, the order of pixels in the first part may be such that a sum of luminance variations between neighboring/adjacent pixels of the first part is maximized. Similarly, the order of pixels in the second part may be such that a sum of luminance variations between neighboring/adjacent pixels of the second part is maximized.

As a specific example, the first part may comprise the pixels M, G, B with the relative (maximum) luminances of respectively 2, 7 and 1. By arranging these pixels in e.g. the sequence of B, M, G a total luminance difference between adjacent pixels will be (3−1)+(7−3)=6. However, by rearranging the pixels in the order of M, G, B a total luminance difference between adjacent pixels of (7−3)+(7−1)=10 is achieved. The increased luminance difference between adjacent pixels provide a higher frequency variation without affecting the effective pixel resolution and thus may in particular reduce the visibility of the pixel (and sub-pixel) structure.

Therefore, whereas the described approach to some extent conflicts with the prior art objective of high frequent (i.e. sub-pixel-alternating) luminance variation, it is possible to introduce a high frequency component by arranging the pixels within each effective pixel to provide a high frequency variation.

It will be appreciated that the above examples describe an approach with specific focus on particular characteristics of the pixels and sub-pixels of a display. However, it will be appreciated that the specific preferred structure for each display depends on the specific characteristics of the individual display. In particular, it will depend on the specific chrominance and luminance characteristics for each primary colour for that display.

FIGS. 14-16 provide specific examples of particularly advantageous sub-pixel arrangements for a six primary display with the primaries Red(R), Green (G), Blue (B), Yellow (Y), Magenta (M) and Cyan (C). The examples provide a highly advantageous trade-off and combination of characteristics and in particular provide a high effective resolution with similar effective pixel characteristics combined with a low sub-pixel visibility at mid grey levels. This is achieved together with multi-domain driving using brighter and darker sub-pixels thereby improving the off-axis visual characteristics.

Particularly advantageous performance can be achieved by employing a pixel repetition block having a first sub-pixel row which comprises a higher luminance magenta sub-pixel, a lower luminance green sub-pixel, a higher luminance blue sub-pixel, a lower luminance red sub-pixel, a higher luminance yellow sub-pixel, and a lower luminance cyan sub-pixel.

Indeed particularly advantageous performance may be achieved by the higher luminance magenta sub-pixel, the lower luminance green sub-pixel, and the higher luminance blue sub-pixel being consecutive sub-pixels; as well as the lower luminance red sub-pixel, the higher luminance yellow sub-pixel, and the lower luminance cyan sub-pixel being consecutive sub-pixels. In many embodiments, improved performance may be provided by maintaining the consecutive sub-pixels in the specific order listed in the previous sentence. In particular, a pixel repetition block with a first sub-pixel row having a sequence of sub-pixels as indicated in FIG. 14-15 or 16-17 may be particularly advantageous.

Indeed, improved performance may often be found if the pixel repetition block comprises a second pixel row, such as e.g. for the examples of FIGS. 14-17. The second pixel row may advantageously comprise the same pixels with a sub-pixel row comprising a lower luminance magenta sub-pixel, a higher luminance green sub-pixel, a lower luminance blue sub-pixel, a higher luminance red sub-pixel, a lower luminance yellow sub-pixel, and a higher luminance cyan sub-pixel.

Again, advantageous performance may be achieved by the lower luminance magenta sub-pixel, the higher luminance green sub-pixel, the lower luminance blue sub-pixel being consecutive sub-pixels, as well as the higher luminance red sub-pixel, the lower luminance yellow sub-pixel, and the higher luminance cyan sub-pixel being consecutive sub-pixels. In many embodiments, improved performance may be provided by maintaining the consecutive sub-pixels in the specific order listed in the previous sentence. In particular, a pixel repetition block with sub-pixel rows having a sequence of sub-pixels as indicated in FIG. 14-15 or 16-17 may be particularly advantageous.

In some embodiments, the first (and often second) pixel rows may comprise a plurality of pixels for at least a first primary. Indeed, the magenta primary is very effective in increasing the efficiency of the display, but it comes at the cost of reduced luminance in the other saturated colors. This is particularly a problem for red colors, so an alternative 6 pixel row layout may use a red primary instead of the magenta primary to increase the red luminance (thereby being more like a 5-primary display). The described approach may also be used for such a display. For example, the layout derived for an RGBCMY display may be generated by replacing M sub-pixels with R sub-pixels.

Thus, following from the examples of FIGS. 14-17 and replacing the references for the magenta sub-pixel with a reference to a second red sub-pixel an efficient and advantageous layout may be generated for such a display.

Specifically, a particularly advantageous display may be based on a pixel repetition block wherein a sub-pixel row comprises a higher luminance red sub-pixel, a lower luminance green sub-pixel, a higher luminance blue sub-pixel, a lower luminance red sub-pixel, a higher luminance yellow sub-pixel, and a lower luminance cyan sub-pixel.

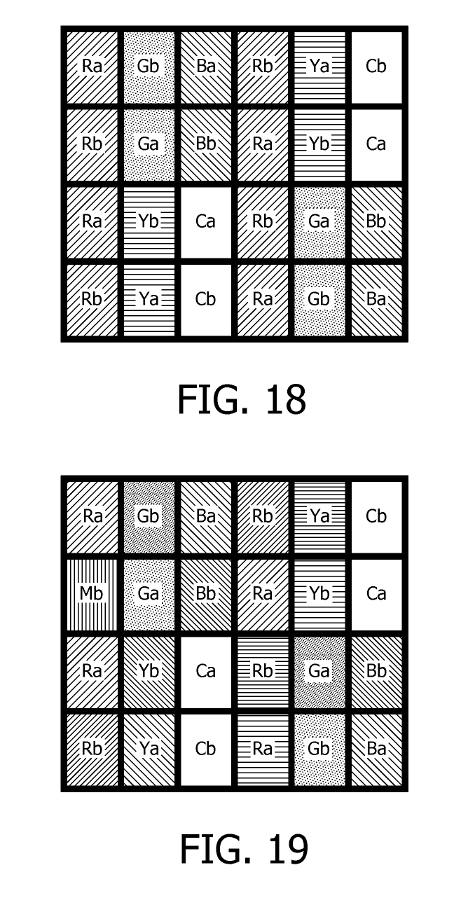

An example is shown in FIG. 18 for a bright image and in FIG. 19 for a mid grey image. In displays using multiple pixels for one primary it may be advantageous to distribute these pixels relatively evenly across the pixel repetition block (and thus across the display). Indeed, in the example of FIGS. 18 and 19 all the red sub-pixels are spread as evenly as possible over the display (i.e. in the same relative position in the 3-sub-pixel groups) thereby reducing structure visibility and increasing resolution.

Indeed, the illustrated layout has additional advantages, since it also has minimal chrominance variation between the 3-sub-pixel groups (RGB and RYC), and each of these groups spans are nearly full-color gamut. This increases resolution, and also requires less complex signal processing to obtain this resolution (‘sub-pixel rendering’). Thus, in the example, a division into a first part of consecutive pixels comprising RGB pixels and a second part of consecutive pixels comprising RYC pixels may provide particularly advantageous performance.

It will be appreciated that the above description for clarity has described embodiments of the invention with reference to different functional units and elements. However, references to specific functional units are only to be seen as references to suitable means for providing the described functionality rather than indicative of a strict logical or physical structure or organization.

The invention can be implemented in any suitable form including hardware, software, firmware or any combination of these. The elements and components of an embodiment of the invention may be physically, functionally and logically implemented in any suitable way.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. A multi-primary display having more than three additive primaries, the multi-primary display comprising a spatial repetition of a pixel repetition block, the pixel repetition block comprising a first pixel row of pixels of primaries, each primary having an associated maximum luminance and each pixel being divided into a plurality of sub-pixels including at least a higher luminance sub-pixel adjacent to a lower luminance sub-pixel, the first pixel row having a plurality of sub-pixels forming at least a first sub-pixel row of the pixel repetition block and a complementary sub-pixel row of the pixel repetition block, the complementary sub-pixel row being adjacent to the first sub-pixel row and comprising a complementary sub-pixel for each sub-pixel of the first sub-pixel row, wherein the sub-pixels are arranged such that a difference between a first combined maximum luminance for higher luminance sub-pixels of the first sub-pixel row and a second combined maximum luminance for higher luminance sub-pixels of the complementary sub-pixel row is no more than 30% of a sum of the first combined maximum luminance and the second combined luminance.

2. The multi-primary display of claim 1 wherein the sub-pixels are arranged such that the difference between the first combined maximum luminance and the second combined maximum luminance is minimized.

3. The multi-primary display of claim 1 wherein the pixel repetition block further comprises at least two pixels for each primary, the pixel repetition block comprising a second pixel row of pixels of primaries, the second pixel row having a plurality of sub-pixels forming at least a second sub-pixel row and a second complementary sub-pixel row, the second complementary sub-pixel row being adjacent to the second sub-pixel row and comprising a complementary sub-pixel for each sub-pixel of the second sub-pixel row, and wherein an order of primaries in the first pixel row is different than an order of primaries in the second pixel row.

4. The multi-primary display of claim 3 wherein the first sub-pixel row and the second complementary sub-pixel row comprise identical sub-pixels.

5. The multi-primary display of claim 3 wherein the first pixel row and the second pixel row are divided into a first part of consecutive pixels and a second part of consecutive pixels and an order of the first part and the second part is reversed for the second pixel row relative to the first pixel row.

6. The multi-primary display of claim 1 wherein the first pixel row is divided into a first part of consecutive pixels and a second part of consecutive pixels and pixels are arranged such that a difference between a first combined maximum pixel luminance for the first part and a second combined maximum pixel luminance for the second part is no more than 30% of a sum of the first combined maximum pixel luminance and the second combined maximum pixel luminance.

7. The multi-primary display of claim 6 wherein an order of pixels in the first part is such that a sum of luminance variations between neighboring pixels of the first part is maximized.

8. The multi-primary display of claim 1 wherein the first pixel row is divided into a first part of consecutive pixels and a second part of consecutive pixels and pixels are arranged such that a chromatic difference between pixels of the first part and pixels for the second part is minimized.

9. The multi-primary display of claim 1 wherein the first pixel row is divided into a first part of consecutive pixels comprising magenta, green and blue pixels and a second part of consecutive pixels comprising red, yellow and cyan pixels.

10. The multi-primary display of claim 1 wherein the first sub-pixel row comprises a higher luminance magenta sub-pixel, a lower luminance green sub-pixel, a higher luminance blue sub-pixel, a lower luminance red sub-pixel, a higher luminance yellow sub-pixel, and a lower luminance cyan sub-pixel.

11. The multi-primary display of claim 10 wherein the pixel repetition block further comprises at least two pixels for each primary, the pixel repetition block comprising a second pixel row of pixels of primaries, the second pixel row having a plurality of sub-pixels forming at least a second sub-pixel row and a second complementary sub-pixel row, the second complementary sub-pixel row being adjacent to the second sub-pixel row and comprising a complementary sub-pixel for each sub-pixel of the second sub-pixel row, and wherein the second sub-pixel row comprises a lower luminance magenta sub-pixel, a higher luminance green sub-pixel, a lower luminance blue sub-pixel, a higher luminance red sub-pixel, a lower luminance yellow sub-pixel, and a higher luminance cyan sub-pixel.

12. The multi-primary display of claim 1 wherein the first pixel row comprises a plurality of pixels for at least a first primary.

13. The multi-primary display of claim 1 wherein the first sub-pixel row comprises a higher luminance red sub-pixel, a lower luminance green sub-pixel, a higher luminance blue sub-pixel, a lower luminance red sub-pixel, a higher luminance yellow sub-pixel, and a lower luminance cyan sub-pixel.

14. The multi primary display of claim 1 wherein the first sub-pixel row comprises alternating higher luminance sub-pixels and lower luminance sub-pixels.

15. A method of providing a multi-primary display having more than three additive primaries, the multi-primary display comprising a spatial repetition of a pixel repetition block, the pixel repetition block comprising a first pixel row of pixels of primaries, each primary having an associated maximum luminance and each pixel being divided into a plurality of sub-pixels including at least a higher luminance sub-pixel adjacent to a lower luminance sub-pixel, the first pixel row having a plurality of sub-pixels forming at least a first sub-pixel row of the pixel repetition block and a complementary sub-pixel row of the pixel repetition block, the complementary sub-pixel row being adjacent to the first sub-pixel row and comprising a complementary sub-pixel for each sub-pixel of the first sub-pixel row, the method comprising:
arranging the sub-pixels such that a difference between a first combined maximum luminance for higher luminance sub-pixels of the first sub-pixel row and a second combined maximum luminance for higher luminance sub-pixels of the complementary sub-pixel row is no more than 30% of a sum of the first combined maximum luminance and the second combined luminance.
